(19) United States
(12) Patent Application Publication
(10) Pub. No.: US 2014/0081742 A1
(43) Pub. Date: Mar. 20, 2014

(54) SYSTEMS AND METHODS FOR OPTIMIZING RETURNS ON AD INVENTORY OF A PUBLISHER

(71) Applicant: MAXIFIER, New York, NY (US)

(72) Inventor: Anthony Katsur, New York, NY (US)

(73) Assignee: Maxifier, New York, NY (US)

(21) Appl. No.: 13/865,399

(22) Filed: Apr. 18, 2013

Related U.S. Application Data
(63) Continuation of application No. 13/800,164, filed on Mar. 13, 2013.
(60) Provisional application No. 61/703,196, filed on Sep. 19, 2012.

(51) Int. Cl. G06Q 30/02

(52) U.S. Cl. CPC G06Q 30/0247
USPC 705/14.46

(57) ABSTRACT

The present disclosure is directed to methods and systems for optimizing economic yield from a publisher's impression inventory. An advertising router may receive economic data from a plurality of placement channels used to place a publisher's impression inventory. The advertising router may be intermediary between the publisher's advertising server and the plurality of placement channels. The advertising router may receive impression inventory data from the publisher's advertising server. The advertising router may generate, based on the impression inventory data, a forecast of economic yield of the publisher's impression inventory. The advertising router may determine, based on the forecast, at least one recommendation to improve the economic yield. The advertising router may apply the at least one recommendation to place an impression of the impression inventory through the plurality of placement channels.

### RELATED APPLICATIONS

This application is a continuation of U.S. patent application Ser. No. 13/800,164, entitled “SYSTEMS AND METHODS FOR OPTIMIZING RETURNS ON AD INVENTORY OF A PUBLISHER”, filed Mar. 13, 2013, which claims priority to U.S. Provisional Application No. 61/703,196, entitled “SYSTEMS AND METHODS FOR OPTIMIZING RETURNS ON AD INVENTORY OF A PUBLISHER”, filed Sep. 19, 2012, both of which are hereby incorporated by reference in their entireties for all purposes.

### FIELD OF THE DISCLOSURE

This disclosure generally relates to systems and methods for managing online advertising. In particular, this disclosure relates to systems and methods for optimizing returns on advertising impression inventory of a publisher.

### BACKGROUND OF THE DISCLOSURE

Online publishers typically offer opportunities for online advertising through their web pages. These may be referred to as impression opportunities or impressions, but may be better known as ad inventory or simply “inventory” A significant segment of the inventory may be available for advertising products, services, or businesses not related to the publisher. This inventory is available to buyers who are typically marketers and advertisers represented by advertising agencies, or directly to advertisers for a price. This inventory is often sold directly by the publisher to the agency or advertiser at a significant price point. What is not directly sold to the buyer may be indirectly sold through trading marketplaces similar to modern day financial markets and trading systems. The inventory sold through these platforms may be known as remnant impressions or simply “remnant”. Remnant impression opportunities may be offered through one or more advertising networks (sometimes referred to as “ad networks”), demand-side platforms (DSPs) and/or supply-side platforms (SSPs) which operate as middlemen. Advertising exchanges may also provide a platform for buying and selling advertising impressions. With a spectrum of partners that a publisher can interface with, it can be difficult to determine an optimal placement for a given ad impression so as to maximize economic yield for the publisher's inventory. As online activity trends upwards and publishers are looking to optimize returns on their advertising inventory, managing impression opportunity transactions have become increasingly sophisticated and challenging.

### BRIEF SUMMARY OF THE DISCLOSURE

In various aspects, the present application is directed to methods and systems for optimizing performance or economic yield on the advertising inventory of a publisher. In many embodiments, the present solutions maximize revenue/margin yield for the publisher across a plurality of secondary channels or placement channels, such as Supply Side Platforms (SSP), Demand Side Platform (DSP) and ad networks (AdNets). The present methods and systems may provide an ad router (sometimes referred to as an economic router) as a layer above present monetization/placement channels for the publisher's ad inventory, such as SSPs, DSPs and ad networks. The ad router may integrate or interface with a publisher's ad server, and may receive impression-specific data from the ad server, as well as ad inventory information, which may include real-time and historical data. The ad router may also leverage from pricing and other information received from the one or more monetization/placement channels, so as to determine an optimal or improved match between inventory and monetization/placement channels. Based on modeling, forecasts and scenario analysis, the ad router may provide one or more recommendations to the publisher or ad server to improve monetary returns and/or performance on the publisher's inventory.

In one aspect, the disclosure is directed at a method for optimizing economic yield from a publisher's impression inventory. The method may include receiving, by an advertising router, economic data from a plurality of placement channels used to place a publisher's impression inventory. The advertising router may be intermediary between the publisher's advertising server and the plurality of placement channels. The advertising router may receive impression inventory data from the publisher's advertising server. The advertising router may generate, based on the impression inventory data, a forecast of economic yield of the publisher's impression inventory. The advertising router may determine, based on the forecast, at least one recommendation to improve the economic yield. The advertising router may apply the at least one recommendation to place an impression of the impression inventory through the plurality of placement channels.

In some embodiments, the advertising router receives economic data from a plurality of placement channels. The plurality of placement channels may include at least one of: an advertising network, a supply-side platform, a demand-side platform and an advertising exchange. The advertising router may receive pricing or transaction data from the plurality of placement channels. The advertising router may normalize the received economic data across the plurality of placement channels. The advertising router may interface with the publisher's advertising server without the use of advertising tags.

In certain embodiments, the advertising router generates the forecast of the publisher's impression inventory based on the impression inventory data and one or more business rules. The advertising router may determine the at least one recommendation to maximize economic yield from the publisher's remnant impression inventory. The advertising router may identify one of the plurality of placement channels for placement of the impression. The advertising router may determine the at least one recommendation based on metrics or goals of the publisher. The advertising router may modify, based on the at least one recommendation, the advertising server's logic for placement of the impression through the plurality of placement channels.

In another aspect, the disclosure is directed to a system for optimizing economic yield from a publisher's impression inventory. The system may include an interface module of an advertising router. The interface module may receive economic data from a plurality of placement channels used to place a publisher's impression inventory. The interface module may receive impression inventory data from the publisher's advertising server. The advertising router may be intermediary between the advertising server and the plurality of placement channels. An optimization engine of the advertising router may generate a forecast of economic yield of the publisher's impression inventory based on the impression inventory data. The optimization engine may determine at least one recommendation based on the forecast to improve the economic yield. The advertising router may apply the at least one recommendation to place an impression of the impression inventory through the plurality of placement channels.

In some embodiments, the interface module receives the economic data from the plurality of placement channels, the plurality of placement channels comprising at least one of: an advertising network, a supply-side platform, a demand-side platform and an advertising exchange. The interface module may receive pricing or transaction data from the plurality of placement channels. The optimization engine and/or interface module may normalize the received economic data across the plurality of placement channels. The interface module may interface with the publisher's advertising server without the use of advertising tags.

In some embodiments, the optimization engine generates the forecast of the publisher's impression inventory based on the impression inventory data and one or more business rules. The optimization engine may determine the at least one recommendation to maximize economic yield from the publisher's remnant impression inventory. The optimization engine may identify one of the plurality of placement channels for placement of the impression. The optimization engine may determine the at least one recommendation based on metrics or goals of the publisher. The optimization engine may modify, based on the at least one recommendation, the advertising server's logic for placement of the impression through the plurality of placement channels.

In some aspects, the present disclosure pertains to methods and systems for optimizing returns on advertising inventory of a publisher. An ad router may receive, via an interface, economic data from a plurality of placement partners. Placement partners may include SSPs, DSPs and ad networks, for example. The ad router may receive, via another interface, impression inventory data from a publisher's ad server, and one or more business rules. A simulator of the ad router may generate a performance forecast of the publisher's impression inventory. An optimization engine of the ad router may generate at least one recommendation to improve performance of the publisher's impression inventory. The ad router may modify, via one or the interfaces based on the at least one recommendation, the ad server's logic for placement of the impression inventory.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIG. 2A is a block diagram depicting one embodiment of a system for optimizing returns on advertising inventory of a publisher; and

FIG. 2B is a flow diagram depicting one embodiment of a method for optimizing returns on advertising inventory of a publisher.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for optimizing returns on advertising inventory of a publisher.

### A. Computing and Network Environment

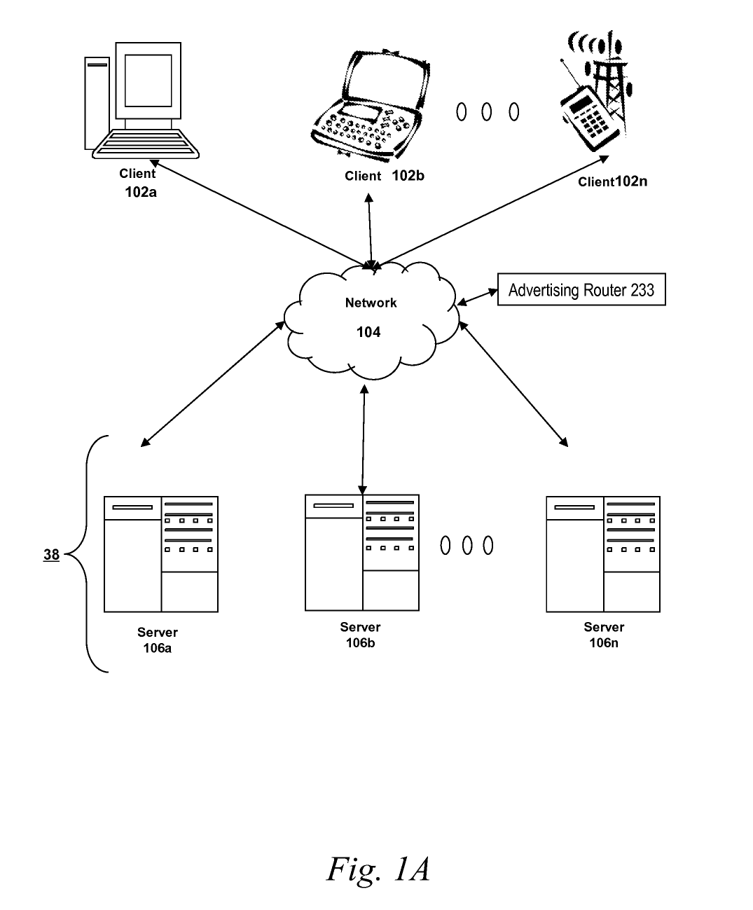

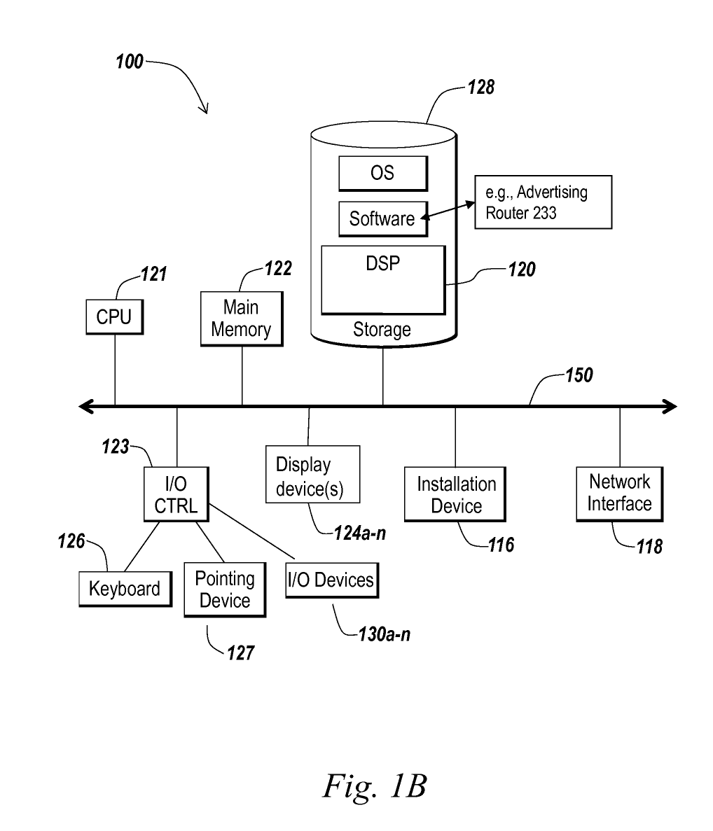

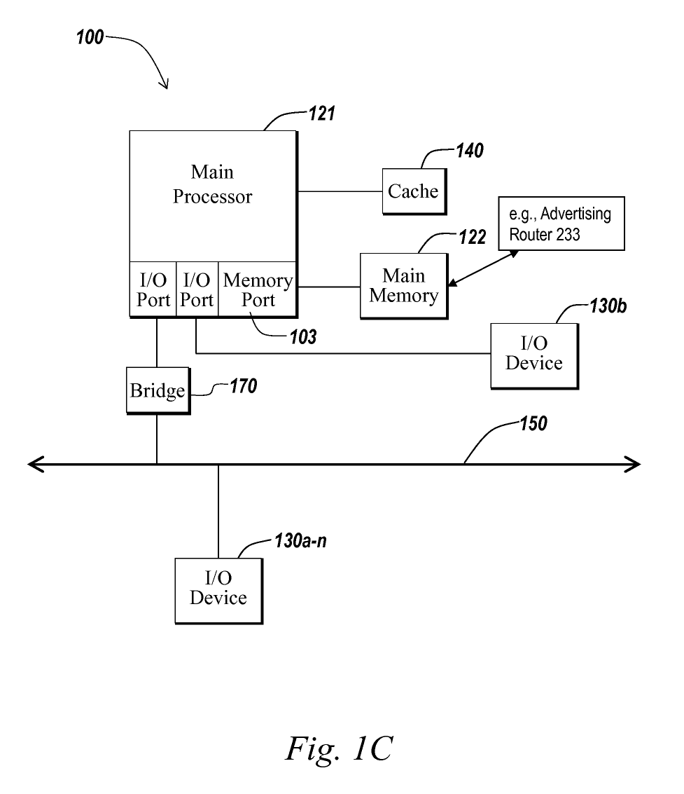

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

In order to manage a machine farm 38, at least one aspect of the performance of servers 106 in the machine farm 38 should be monitored. Typically, the load placed on each server 106 or the status of sessions running on each server 106 is monitored. In some embodiments, a centralized service may provide management for machine farm 38. The centralized service may gather and store information about a plurality of servers 106, respond to requests for access to resources hosted by servers 106, and enable the establishment of connections between client machines 102 and servers 106.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers. In one embodiment, the server 106 provides the functionality of a web server. In another embodiment, the server 106a receives requests from the client 102, forwards the requests to a second server 206b and responds to the request by the client 102 with a response to the request from the server 106b

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-102n, a keyboard 126 and a pointing device 127, such as a mouse. The storage device 128 may include, without limitation, an operating system, software, and a software of a demand side platform 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the software 120 for the demand side platform. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as the MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the communications device 102 includes a combination of devices, such as a mobile phone combined with a digital audio player or portable media player. In one of these embodiments, the communications device 102 is a smartphone, for example, an iPhone manufactured by Apple Computer, or a Blackberry device, manufactured by Research In Motion Limited. In yet another embodiment, the communications device 102 is a laptop or desktop computer equipped with a web browser and a microphone and speaker system, such as a telephony headset. In these embodiments, the communications devices 102 are web-enabled and can receive and initiate phone calls. In other embodiments, the communications device 102 is a Motorola RAZR or Motorola ROKR line of combination digital audio players and mobile phones.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Optimizing Returns on Advertising Inventory for a Publisher

Online publishers typically offer opportunities for online advertising through their web pages. These may be referred to as impression opportunities, but may be better known as impression or ad inventory, or simply “inventory” A significant segment of the inventory may be available for advertising products, services, or businesses not related to the publisher. This inventory is available to buyers who are typically marketers and advertisers represented by advertising agencies, or sold directly to advertisers for a price. This inventory is often sold directly by the publisher to the agency or advertiser at a significant price point. What is not directly sold to the buyer may be indirectly sold through trading marketplaces similar to modern day financial markets and trading systems. The inventory sold through these platforms may be known as remnant impressions or simply “remnant”. Remnant impression opportunities may be offered through one or more advertising networks (sometimes referred to as “ad networks”), demand-side platforms (DSPs) and/or supply-side platforms (SSPs) which operate as middlemen. Advertising exchanges may also provide a platform for buying and selling advertising impressions. Examples of ad exchanges and SSPs include RightMedia, Google AdX, AdECN, Adsdaq, Adbrite, Valueclick, Admeld, SpotXchange, AdNexus, AdBidcentral, Traffiq, OpenX, BidPlace, Facebook, Pubmatic and Yahoo APT.

In one illustrative embodiment, a publisher's primary use of inventory is to monetize their site. The publisher's goods (e.g., publishers like ESPN.com, Forbes.com, CNN.com) is their respective content. The monetization priorities of the publisher may be repsented by the following: 1) Directly sold, 2) Indirectly sold (e.g., through SSPs, Exchanges, DSPs) and 3) House (e.g., unsold and/or used for self-promotion).

In some embodiments, a publisher interfaces, partners or works with a plurality of partners to monetize, place or fulfill an impression opportunity, e.g., with an ad from an advertiser. Partners may include, but is not limited to any one or a combination of SSPs, DSPs, ad networks, ad exchanges, and advertisers. These partners may sometimes be referred to as ad or impression placement channels, monetization channels, remnant channels, ad providers, secondary channels, and/or buy- or demand-side partners (hereafter sometimes generally referred to as “placement channels”). With a spectrum of partners or placement channels that a publisher can interface with, it may be difficult to determine an optimal placement for a given ad impression or for a certain inventory.

Impression opportunities may include any form or type of widget, space or region on a web page or linked to a webpage. Impression opportunities are sometimes referred to generally as advertising (ad) inventory or impressions. This inventory may overlap with or reside within (or as part of) content on the page (e.g., designated locations for banners, block ads, sponsored listings, margin ads and flash displays). Impression opportunities may be temporal, e.g., associated with a time slot (e.g., screening of a sponsored video footage prior to a requested screening, or available on a part of a day referred to as a day part). In some embodiments, certain impression opportunities may not reside directly on a webpage. For example and in one embodiment, an impression opportunity may be generated from a webpage, such as due to an user action or some other trigger. For example, a pop-up may be generated when a webpage is loaded onto a browser. A window display or other widget may be generated responsive to a mouse-over, for example. In some embodiments, an impression opportunity may include one or more elements such as a banner and an animated flash display extending from the banner boundary. In some embodiments, elements that may individually qualify as an impression opportunity may be collectively packaged as a single impression opportunity. In some embodiments, an impression opportunity is sometimes referred to as advertising “inventory” of a publisher.

In some embodiments, the placement channel (e.g., SSP or ad agency) for an ad impression may make a bid and the sell side (e.g., publisher) may set a floor for accepting a bid. The publisher may accept the highest bid from multiple sellers. In some embodiments, the publisher may accept a lesser bid for a particular impression so as to position other inventory for better returns.

Publisher inventory may fall into several categories which may be distinct or may overlap. In some embodiments, ad inventory may be classified or categorized into two categories, premium and remnant. These two categories may be distinct. These inventory classes are sometimes known as class 1/guaranteed or unsold/non-guaranteed respectively. Premium inventory may be directly sold by the publisher at a fairly high price (e.g., <$15 CPMs). A publisher's premium sell-through rates (STR) are typically not 100%. In some embodiments, the premium STR may range somewhere between 40-80% for example, depending on the publisher. The remaining inventory which has not been sold may be classified as remnant inventory. Remnant inventory can be monetized via various placement channels, such as Supply Side Platforms (SSPs)—Pubmatic, AppNexus and Rubicon, or Ad Networks—UnderTone, ValueClick and Martini Media. Publishers may monetize remnant inventory directly through DSPs, such as MediaMath, Turn or Google's Invite Media. There can be literally dozens upon dozens of unsold placement or untapped monetization channels. A part of this monetization process may sometimes be brokered or facilitated by an intermediary or a partner (e.g., SSP, ad exchange). However, each partner usually represents merely a portion of the buying opportunities for a particular ad impression. Thus, in certain embodiments, a publisher may interface or engage with a number of partners which may be interested in the publisher's ad inventory. Due to the non-uniform transaction interface provided by each partner, it may be difficult to determine a preferred partner for a particular context or revenue target. This can be true in general, for a particular ad campaign, or for a particular impression opportunity bid. In some embodiments, the systems and methods disclosed herein provide a single interface for a publisher that optimizes the publisher's ad transactions across one or more buy-side partners.

As publishers' revenues from online advertising continue to grow, optimizing the performance of display, video, social and mobile campaigns may become increasingly important, e.g., for large media companies. The task of optimizing performance may be daunting and complicated, because the online ad ecosystem has several layers of complexity. For example, getting a handle on real-time data flows, assessing actual campaign performance, forecasting needs, staying ahead of share stealing competitors, and justifying cost per milles (CPMs) can make optimization a challenging endeavor. Without a feasible way to optimize performance, advertisers and publishers may be frustrated with unrecognized revenues. For example, one study suggested the standard deviation of publishers' forecasts ranges between 25-50%. Publishers may attempt to manage their online ad operations with a limited tool set from ad servers and/or with manual spreadsheet methods. Guesswork was often the norm as ad operation teams sorted significant amounts of aged data to deduce actual performance or forecast inventory. Very often, such processes can result in arbitrary results, and can even cause harm. Even advanced spreadsheet analysis are insufficient to properly manage and optimize the billions of transactions that pass through the online advertising ecosystem. Often, it is too much data flowing in too many directions at every minute of the day. And even some of the best efforts can take too long and are too inefficient. Likewise, single technology point solutions that slice historical data on different metrics may offer only marginal benefits because the publisher still lacks context for optimizing campaigns. While a single tool may offer insight into Click-Through Rates (CTRs), for example, it may not have capability to show the impact on revenue, or vice versa.

Within the online advertising environment, an ability to meter clicks and engagement can enable a campaign to be measured against these performance metrics. Some campaigns sold on a traditional CPM basis by publishers, are increasingly judged on CTR. Of various participants in the online advertising environment, publishers may stand to gain or lose significantly because of the publisher's content, pages and/or inventory that frame the market opportunity. Selling every potential impression and then delivering them as promised are constantly moving targets. It can be very challenging for a publisher to determine with specificity how much remnant inventory has not been monetized to its maximum potential each month. Sub-optimal revenue optimization may result in lost revenue opportunities for the publisher.

While publishers have the opportunity to monetize their remnant through many or all of these channels to achieve the greatest price, the logistical challenges this represents can be overwhelming. By way of illustration, publishers may have to ingest a significant amount of economic data from some or all monetization partners. The publisher may have to model the economic data, which may include pricing data, including but not limited to historical, predicted and/or real time data. For example, economic data may include bid prices, such as highest bid prices, successful bid prices, initial bid prices, real time bid prices, sell-through prices, demand for impressions, number of bids, commissions for click through, and any other pricing or business arrangements. The economic data may pertain to particular types of impressions, such as impressions within a particular website or website section, for a specific day part, week part and/or any time segment, for a particular geographic region (e.g., U.S. Northeast), and targeted for a particular audience segment or channel (e.g., age-group, known interest in a certain topic/product). The economic data may sometimes be referred to as pricing, bid, transaction, billing or sales data or records. The publisher may have to manually analyze the economic data and manually re-route ad inventory to certain placement channels. For example, a publisher may reroute inventory by changing parameters in the publisher's ad server by hand or via limited reprogramming. It can be impractical and inefficient to use spreadsheets to manually manipulate even a subset of ad server parameters.

The present disclosure describes embodiments of a solution which can provide tools (e.g., programmatic tools) to analyze information from various sources and perform optimization of ad operations. In some embodiments, the solution includes an economic router or ad router. The ad router may provide a publisher with a streamlined window into actual campaign and network performance, and an automated, intelligent system that can recommend adjustments, project results and maximize economic yield or performance. The ad router is scalable and can optimize many impressions, for example, many tens of billions of impressions each week or month. The ad router may provide tools to visualize what is happening inside or relevant to a campaign or set of campaigns, e.g., so that a publisher's ad operations can make informed decisions with respect to making campaign adjustments with a clear, holistic and/or contextual view on the campaign's performance. The ad router may produce a forecast or projection of available inventories based on an array of variables. For example, the ad router may recognize characteristics and/or nuances between different types of inventory and its availability. The ad router may automatically implement changes or may convey the information to the publisher or the publisher's ad server to make an informed decision.

In some embodiments, the ad router may optimize campaigns based on advanced algorithms and/or historical performance data. The ad router may identify underperforming campaigns, e.g., so that these campaigns can be adjusted automatically and immediately to optimize publisher revenue, eCPM and/or CTR. The ad router can simulate campaigns based on recommended adjustments. The ad router can calculate many (e.g., billions of) permutations (e.g. scenario analyses) that are required to accurately simulate campaigns. The ad router can report on up-to-date campaign performance which can be delivered to advertisers or other constituencies. For example, up-to-date performance data may be reported and offered as proof of performance that represents proof of value to advertisers. In some embodiments, the ad router may manage yields and/or inventory availability to ensure appropriate, maximum pricing for online ads. The ad router can display key performance indicators (KPIs) across different metrics, e.g., on a dashboard or in report format. In some aspects, the ad router comprises a platform or engine that binds and integrates some or all of these features together, so that publishers may reach the publishers' revenue potential.

In some embodiments, the ad router makes decisions to optimize or maximize the economic yield from remnant inventory of a publisher. The economic yield for the publisher may be based on revenue of the remnant inventory, margin yield of the remnant inventory or a combination of or balance between revenue and margin yield. The ad router may be designed and constructed to improve, optimize or maximize revenue and/or margin yield for a publisher across a plurality of secondary channels (e.g., SSPs, DSPs, AdNets). The ad router may include or use an algorithm, logic, operation or business rule that determines which secondary channels may be used to improve the economic yield of the publisher's remnant inventory. The ad router may include an algorithm, logic, operation or business rule that determines which secondary channels may be used during which day or week parts to improve the economic yield of the publisher's remnant inventory. The ad router may include an algorithm, logic, operation or business rule that determines which secondary channels may be used in which geography to improve the economic yield of the publisher's remnant inventory.

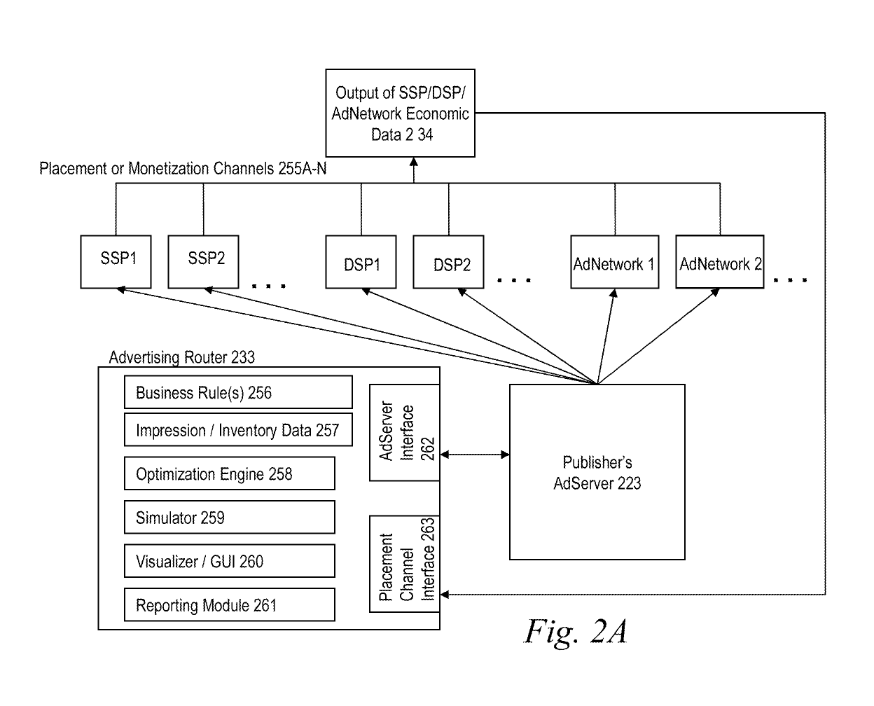

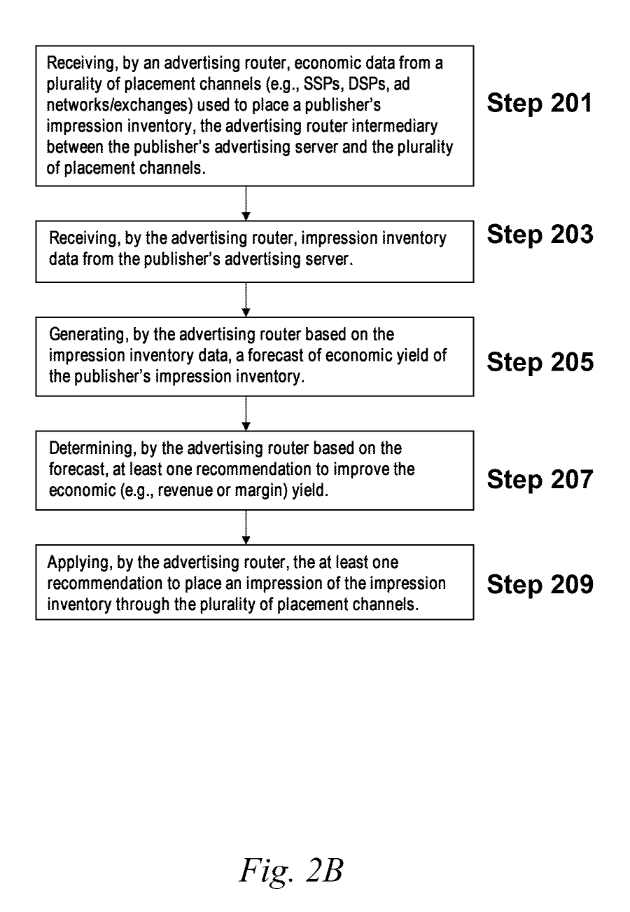

Referring to FIG. 2A, one embodiment of a system for optimizing returns on ad inventory of a publisher is depicted. In brief overview, the system may include a networked environment of one or more devices, such as a publisher's ad server, and one or more platforms or devices representative of placement channels. In some embodiments, the present systems include an economic router or ad router (hereafter sometimes generally referred to as “ad router”). The ad router may be designed and/or built to perform one or more of the following: i) integrate or interface with a publisher's ad server, ii) access or extract economic data from one or more placement channels, iii) access or extract impression-related information (e.g., inventory data) from the ad server; iv) receive or generate one or more business rules for a publisher's campaign(s), v) predict or model performance of the publisher's inventory, vi) provide optimization recommendations for the publisher's inventory, vii) implement optimization changes to the one or more business rules and/or campaigns, viii) provide scenario analysis based on particular optimization approaches, ix) determine a placement channel for one or more impressions, and/or x) generate instructions for, or manipulate the logic of an ad server, to fulfill an impression and/or operate the publisher's campaign(s). In some embodiments, the ad router may perform (e.g., on demand) reporting of various ad operations and/or campaigns, e.g., against a number of performance metrics such as click-through rates (CTRs).

A publisher's ad server may include one or more servers, e.g., a network of cloud servers or a machine farm as described above in connection with FIG. 1A. An ad server may be owned and maintained by a company or entity other than the publisher. In certain embodiments, a publisher owns and/or operates its own ad server. Examples of ad servers include, but are not limited to DART for Publishers owned by Google, Open Ad Stream owned by 24/7 Media (a WPP company), and Helios AdTech owned by AOL. Ad inventory, whether premium or remnant, may be handled by the ad server. The ad server may operate as a decision engine to ensure that an ad “creative” is delivered based on fixed rules to an individual. Ad requests can come from the publisher directly or a secondary channel such as a MediaMath. The ad server may be described as the final mile to serve an ad, e.g., whether the ad request came from Pubmatic, UnderTone or MediaMath. By interfacing with an ad server, the ad router may be configured to act as a final arbiter of which partner receives an ad impression for placement, which may be based on optimal economic benefit or yield to the publisher.

In some embodiments, the ad router may integrate or interface with the ad server for access to some or all ad server data at the impression level. The ad router may receive or be informed of some or all characteristics of that impression, such as page level information (e.g., page position, creative size, creative type), publisher section upon which the impression appears (e.g., tech, sports or home page), the time of day of the impression, how a similar impression performed (e.g., if a click occurred, etc). Ad server data may include any user, system or geo data in connection with an impression opportunity. User data may include any type or form of data related to a user of a webpage, website, web session and/or web application. Such user information may include geolocation or geographical (sometimes generally referred to as “geo”) information and system data. Geo information may include information including but not limited to information related to the user network, internet protocol (IP) address, access point (e.g., wifi hotspot), geographical location and mobile tracking, and demographic and other geographical information system (GIS) data linked to the user location. System data may include any user information stored or tracked by the publisher, including but not limited to user preferences, browsing and transaction history, and user device information. Some of these information may be tracked by cookies and/or Adware.

Ad server data may include information including but not limited to information related to the content and web traffic of the publisher or website offering the impression opportunity. The ad server data may include impression-specific information, such as ad size, day part and week part information. Ad size may indicate the size of the impression opportunity using any type or form of measure, e.g., digital image dimensions by pixels, such as 300×250. Day part information specifies portions of the days during which the impression opportunity is offered, e.g., 12 pm-6 pm, 6 pm-9 pm, primetime, morning segment, late night, etc. Week part information may specify between weekend and weekday offerings. Other time-specific parts may be provided or defined. Ad server data may include channel data. Channel data may include information including but not limited to information related to the type and reach of a media channel associated with an impression opportunity. A channel may be a category of media content targeting a specific audience. For example, channels may include categories such as news, finance, sports, women, men, etc. In some embodiments, a channel may be a media type, for example, rich media, in-stream video, search, banner, text links, e-mail spam, opt-in e-mail advertising, other trackable media. Media type channels may also include podcasts, mobile device content and RSS feeds.

In certain embodiments, the ad router include the ability to directly or indirectly monitor, access, ingest and/or analyze a publisher's data feeds from the publisher's remnant placement channels. An ad router may have access to such information by interfacing, integrating or communicating with an ad server of the publisher. For example, an ad router may have access to the sale price for a particular impression. The publisher may technically own such data as these data are information about the publisher's impression. The ad router may produce or generate any form of insight and analytics from a publisher's data feeds. By combining and/or modeling various data points from the ad server, the ad router can determine an optimal or preferred approach to place an impression, e.g., the who, what, where and when a publisher should provide their inventory to each placement channel.

By way of example, a publisher may have an STR of 60% of their premium. The publisher may work with Pubmatic, UnderTone and Rubicon to monetize the publisher's unsold 40% (e.g., remnant). For the publisher's Technology section of their website for example, on Mondays between 9AM and 12PM in the NorthEast, PubMatic may achieve a $1.85 return on the impression (e.g., bid price that the publisher may accept), UnderTone may achieve a $1.64, Rubicon may achieve a $1.94. The Ad router may send the inventory to, or place the inventory with Rubicon during that time period for the corresponding geo and/or time segment. It may be possible that UnderTone better monetizes the same section on the same day during the same time period in the Southeast. The ad router may determine or predict this, and may send the Southeast inventory to UnderTone.

In some embodiments, the ad router is referred to as a meta router. The ad router may be implemented as a layer additional to or above one or more SSPs or another of the publisher's partners. The ad router can work or interface with a plurality of SSPs and/or other partners. The ad router is unlike a SSP, since a SSP may not work or interface with other SSPs (e.g., due to competing campaigns, advertiser inventory and/or interface formats). Instead, the ad router can allow a publisher to efficiently operate or interface with all or a number of SSPs. The same is true with ad networks and DSPs. The publisher can work with one or more ad networks, DSPs and/or other placement channels via the ad router. In some embodiments, the ad router may interact with one or more ad networks, DSPs and/or other placement channels without any of the placement channels being aware of the presence, role and/or impact of the ad router or other placement channels. In certain embodiments, the ad router may interface with one or more placement channels, e.g., on behalf of the ad server. For example, the ad router may provide a wrapper around the ad server, such as a front-end interface to the placement channels. The ad router may operate as a layer between the ad server and one or more placement channels. In some embodiments, the ad router may modify the logic (e.g., one or more business rules, software modules, application tools, publisher campaigns) of the ad server. For example, the ad router may alter how an impression is placed across one or more placement channels, may execute an agent on the ad server to collect data from the ad server and/or placement channels, and may provide a graphical user interface for the publisher to view ad operations performance.

In some embodiments, the ad router interfaces with the ad server without a need for tags or ad tags. For example, when a browser navigates to a publisher website, the publisher's web server or ad server does not have to generate a coded link known as a tag, to communicate or interact with the ad router. In certain embodiments, ad router operation is described as tagless. The ad router may integrate with and/or manipulate the ad server logic, e.g., rather than using tags. The ad router direct, send instructions to, or otherwise control or manage the ad server via custom or standard communications or messaging protocols, e.g., rather than using tags. The ad router's operations, e.g., to integrate with and/or manipulate the ad server logic, may be automated or explicitly configured, monitored and/or approved by the publisher.

In some embodiments, the ad router is designed and built to be a single, integrated platform with embedded, advanced algorithms that generates recommendations to publishers on how to improve the performance of the publishers' online ad operations and associated sales initiatives. The ad router may perform one or more of the following: i) provide clear visualization of performance data, ii) set rules for performance, iii) automate changes and recommendations, iv) adjusts campaigns intra-cycle, v) offer holistic and contextual simulations, vi) provide accurate forecasting, vii) streamline ad operations and efficiencies, viii) improve publisher economics through the maximization of revenue and margin yield and viv) maintain transparency and provide users with as much or as little hands-on control as desired. With these embodiments of the ad router, the present disclosure provides performance, simplicity, processing algorithms and reporting not previously offered in a single integrated solution and service. Certain embodiments of the ad router may be offered, delivered or deployed as a software/hardware combination, a service or a managed service, application or platform.

Referring again to FIG. 2A, the ad router may include an ad server interface (e.g., first interface). The ad router may include an interface module that includes the ad server interface. The ad server interface may comprise an application programming interface (API) with the ad server. The ad router may include a physical and/or wireless interface with the ad server. The ad server interface may be designed and/or built to access data from the ad server, such as impression-related or inventory data (e.g., impression-specific descriptions, past performance, inventory across websites and website sections, remnant inventory forecast, clearing prices), campaign data (e.g., campaign rules, goals, performance), business rules (e.g., pricing thresholds, discounts, general campaign rules, CTR targets), available placement channels (e.g., SSP, ad networks), as examples. The ad server interface may include a receiving or polling module to access ad server data dynamically as data becomes available, or at certain times (e.g., corresponding to certain events, such as in response to a user command or a schedule). In some embodiments, the ad server interface receives a data feed from the ad server, or from the publisher via the ad server. The ad server interface may include a filter, parser and/or translating engine to extract and/or process information received from the ad server. The information received may be proprietary in format, or arranged according to a standard format. In some embodiments, the ad server interface may incorporate features of an extract, transform and load (ETL) engine to process the ad server data.

In some embodiments, the ad router may include a placement channel interface (e.g., second interface). The placement channel interface may be part of the interface module. The placement channel interface may include any one or more of the features described above in connection with the ad server interface, configured to access, receive, poll, normalize or extract data from one or more placement channels. In some embodiments, a placement channel interface is a dedicated interface with a particular placement channel. In other embodiments, a placement channel interface may communicate with a plurality of placement channels. The placement channel and/or interface module may be scalable and configurable to interface with an unlimited number and/or types of placement channels. The placement channel interface may share some of the features or elements of the ad server interface. For example, these two interfaces may use time-division multiplexing to share a certain module between the two interfaces. In some embodiments, the ad router includes a single interface to access, receive, poll, extract and/or normalize data from both the ad server and placement channel(s). One or more placement channels may generate or output data, such as economic data (e.g., pricing, transaction, bid information). In some embodiments, the data may include impression-level revenue and/or transaction data, including real time and/or historical data. The ad server may request and/or receive some of this data and may convey the data to the ad router via the ad server interface for example. In certain embodiments, one or more placement channels may generate the data into a file, which may be accessed or transmitted to the ad server and/or ad router.

In some embodiments, the ad router may interface with or receive third-party information or analytics. The ad router may incorporate such data into the ad router's optimizations and/or simulations. Third-party segment information may include information identifying specific audience segments with certain online shopping habits. A number of companies, such as BlueKai, Exelate and Axciom, may provide such insights into the in-market shopping profiles of advertisers and/or site audiences. Third-party segment information may include information related to a conversion (e.g., pattern of user behavior and/or advertising characteristics leading to a newsletter sign-up, registration, transaction, etc) as well as behavioral targeting data sourced or bought from ad networks. Publishers can use pre-existing segments or use the information provided to create custom audience segments, identify matching impression opportunities and reach prospects, e.g., via the ad router.

Referring again to FIG. 2A, and in certain embodiments, the ad router includes a plurality of modules for performing various operations of the ad router. For example, the ad router may include at least one interface module, a visualizer 260, an optimization engine 258, a simulator 259 and a reporting module. Any one or more of these modules may be embodied in hardware or a combination of hardware and software. Each module may include any script, program, agent, state machine, component or set of executable instructions executing on a processor of the ad router and/or ad server.

The ad router may include an user interface or visualizer 260. The visualizer 260 may include any type or form of interface, including a graphical user interface (GUI) and/or a command line interface. The visualizer may include a web access portal and/or a software application interface (e.g., a mobile app). The visualizer may provide a display interface and/or interactive interface. The visualizer may organize and/or present some of the data received and/or processed from the ad server and/or placement channels. The visualizer may include or present a series of intuitive steps to guide a user in visualizing actual campaign performance and/or measuring performance against key metrics and objectives. For example, the visualizer may present and measure campaign performance in one or more screens, and may provide the publisher with adjustment/remedial control over a campaign. The ad router may access or extract data from the ad server and/or publisher. For example, the visualizer may display information from general campaign views to ultra-granular information in a single screen or other suitable layout across a plurality of screens. The visualizer can present data against the publisher's defined business rules, and can make these information immediately actionable. For example, the visualizer may compare performance data against business rules to show where individual campaigns are currently over or under performing.

In some embodiments, and by way of illustration, the visualizer may provide a general campaigns view, which includes, for example, the unique campaign identifier and name, identifies the advertiser and/or agency, and/or identifies the ad trafficker responsible for the campaign. The visualizer may display publisher or campaign goals, such as target impressions (e.g., impression type, of a certain day part and/or geographical region), via metrics such as CPM/CPC/DR, completion conditions (e.g., end date, number of impressions/clicks), and/or start and end dates. The visualizer may display publisher or campaign delivery statistics, such as delivered impressions, over/under-delivery of impressions, the number or rate of clicks, acquisition statistics, CTR from start to current, CTR in the last seven days (or any other period), and/or an effective CPM.

The visualizer may display publisher or campaign forecast(s), such as Cost Per Acquisition, forecast of impressions to be delivered by end date, the amount and/or type of impressions not yet delivered, and remaining days to end date (e.g., of campaign). The visualizer may display publisher or campaign level statistics, such as daily statistics. For example, the visualizer may present statistics of impressions and/or clicks delivered yesterday/today, or over any time period, forecasted impression statistics, statistics of impressions that should be delivered per day per the system schedule, average statistics of daily impressions delivered during the last seven days (or any other time period), actual statistics of impressions delivered during the last seven days (or any other time period), and/or forecasted statistics of impressions for the next seven days (or any other time period).

In some embodiments, after the visualizer presents the data for viewing, the ad router may automatically forecast performance based on past performance for the next 7/14/28 days, for example. The ad router may include a simulator 259 or forecasting engine to perform the forecasting. In some embodiments, the simulator and/or the optimization engine operates as a single engine, or parts of an engine, to perform forecasting and optimizations.

The simulator may analyze historical patterns at the individual page/placement level in order to create an inventory forecast. This may allow for greater insight into prospective campaign performance, allowing the simulator to forecast behaviors of individual campaigns across applicable inventory. In looking forward, the simulator may apply its forecast to each individual campaign, and may apply a forecast to all or a subset of campaigns simultaneously. The simulator may predict the performance of each individual campaign against the simulator's inventory forecast. The resulting forecasts and predictions can provide the publisher with a picture of what areas are most likely to underperform and what inventory is available (e.g., by section on the site).

In certain embodiments, the ad router includes an optimization engine 258. The optimization engine may be designed and/or built to produce recommendations to the publisher based on forecasted inventory and/or performance. The optimization engine may provide recommendations and/or other information to a publisher to make informed decisions to optimize performance of the publisher's ad inventory. The optimization engine may incorporate or employ algorithms that perform multi-pronged or parallel analyses. For example, one algorithm/analysis may focused on an individual campaign and another one focused on all other campaigns running at the same time. The optimization engine may present a series of optimization recommendations based on the analysis. The optimization engine may recommend optimizations based on the publisher's metrics and/or goals, such as economic yields like margin or revenue yields. For example, the optimization engine may generate campaign optimizations based on metrics including but not limited to CPM, Cost per click (CPC), cost per action (CPA), cost per sale (CPS), effective CPM, revenue, CTR, return on investment (ROI), and/or other publisher-defined criteria. An eCPA or CPA may be used as a measure of the effectiveness of impression opportunities procured by an advertiser. For example, an ad campaign may involve multiple bids over a plurality of impression opportunities. To determine the eCPA, the bid price for successful bids may be summed over a period of time and divided by the number of desired user actions (e.g., a form submission or purchase) linked to an advertisement. The larger the number of desired user actions, the more successful the ad campaign is as the eCPA is reduced. CTR can be a way of measuring the success of an advertiser campaign, and may be obtained by dividing the number of users who clicked on an ad on a web page by the number of impression delivered.

The publisher may choose to automatically accept the recommendations from the optimization engine (e.g., based on the publisher's self-defined business rules and/or configuration of the ad router and/or ad server). In this case, changes to the publisher's campaign(s), ad operations and/or business rules can be automatically effected on the corresponding ad server. The publisher can make custom adjustments to the recommendations from the optimization engine. The optimization engine and/or the visualizer may update the publisher in near real-time on how the adjustments are affecting a corresponding campaign and/or an entire site. The optimization engine may monitor an entire site when a new change is requested so that the publisher can be informed how a change impacts other campaigns.

In some embodiments, the optimization engine may perform optimization (e.g., sequential optimization) based on campaign simulation or forecast. For example, a publisher's defined business rules may not have adequately predicted or addressed certain events which may be unexpected (e.g., a plane crash or natural disaster), which may drive significant traffic to a site. The publisher can perform various simulations via the optimization engine and/or simulator, based on additional or different business rules or other updates. The simulations can allow the publisher to see how the new or updated business rules or changes may impact a campaign and/or other campaigns. The optimization engine and/or simulator may perform one or more simulations in context, so as to provide the publisher with an accurate perspective on the impact of potential changes across a portion of the inventory or an entire site for example.

The optimization engine may incorporate new or updated data from the ad server and/or placement channels in its optimizations. The optimization engine may incorporate the new or updated data dynamically when these become available. The optimization engine may incorporate the new or updated data at specific intervals or checkpoints, based on specific triggers (e.g., performance drops or lag) or according to a schedule. The optimization engine may include a feedback process and/or goal to refine and/or test its recommendations. For example, the optimization engine may interoperate with the simulator to perform incremental updates and/or multi-factor scenario analysis. The optimization engine may continue to refine its optimizations until a goal is met and/or until a predicted incremental improvement falls below a threshold, for example.

In some embodiments, the optimization engine produces optimizations that can increase advertisers' return on investment (ROI). The ad router can also allow ROI to be demonstrated through comparisons with past performance, prediction performance without optimization, and actual performance improvements. The optimization engine may propose new and/or improved inventory structures, which can result in improved inventory yields and incremental revenues. In some embodiments, the optimization engine prioritizes and/or maximizes as operations and revenue for a publisher, campaign and/or advertiser. The optimization engine may help the publisher prioritize adjustments on-the-fly, by providing structured and/or up-to-date recommendations. In certain embodiments, the optimization engine can improve overall yields and revenue by prioritizing campaigns. For example, by focusing on increasing overall campaign performance and revenues, the optimization engine can better schedule campaign delivery according to the overall yield resulting in more ad impressions being delivered and monetized.

In some embodiments, the optimization engine can maximize revenue opportunities or potential, e.g., with direct response initiatives. For example, by reducing the direct response eCPM for performance-based campaigns (e.g., on the publisher's premium inventory), advertisers may be more likely to respond with a higher STR. In some embodiments, the optimization engine may statistically and/or intelligently process or analyze information from the ad server to help an advertiser customize, determine or develop an advertising campaign based on the advertiser's goals. The optimization engine may dynamically update the metrics to help an advertiser adjust or implement advertising campaigns based on the goals. For example, the optimization engine may determine availability of daily impression opportunities across sections of a site, or across sites, to identify an appropriate advertising campaign strategy. The publisher may use optimization engine outputs to price the impressions with respect to the advertiser's performance goals.

In certain embodiments, the ad router include a reporting module 261. The reporting module can provide advertising intelligence reporting (AIR). The reporting module may include a number of tools to produce standard and/or custom reports on particular campaigns for various constituencies inside the publisher. The reporting module may generate reports and/or other data formats dynamically (e.g., on demand, or as campaigns progress), or in response to a schedule. The reporting module may interface with the visualiser to present certain data and/or reports to a publisher. In some embodiments, AIR is provided on a management dashboard (e.g., on the visualiser) that provides aggregated and/or detailed rolling metrics across an entire site. This dashboard feature can provide insights into campaign and/or site-wide performance, and may enable a publisher to take affirmative steps to further improve the publisher's overall online ad programs.

The reporting module may be designed and constructed to report on or provide a dashboard for any economic data, performance and operation to assist with and/or report on maximizing revenue and/or margin yield for any one or more publishers. In some embodiments, the reporting module may include one or more reports and/or dashboard the identifies, aggregates and calculates publisher economic yield across a plurality of secondary channels such as SSPs, DSPs and AdNets. A user may be able to select the economic returns and/or yields for a particular publisher across a particular secondary channel. A user may be able to select the economic returns and/or yields for a particular publisher across a particular day or week part. A user may be able to select the economic yields for a particular publisher across a particular geography. A user may be able to select the economics and/or yields for a particular publisher across a particular category or content type.

Referring now to FIG. 2B, one embodiment of a method for optimizing economic yield or returns on ad or impression inventory of a publisher is depicted. In brief overview, the method receiving, by an advertising router, economic data from a plurality of placement channels (e.g., SSPs, DSPs, and ad networks) used to place a publisher's impression inventory (201). The advertising router may be intermediary between the publisher's advertising server and the plurality of placement channels. The ad router receives impression inventory data from the publisher's advertising server (203). For example, the ad router may receive, via another (e.g., second) interface, impression inventory data from a publisher's ad server, and one or more business rules. The ad router (e.g., via a simulator of the ad router) may generate, based on the impression inventory data, a forecast of economic yield of the publisher's impression inventory (205). The ad router (e.g., via an optimization engine of the ad router) may determine, based on the forecast, at least one recommendation to improve the economic yield (207). The ad router may apply the at least one recommendation to place an impression of the impression inventory through the plurality of placement channels (209).

Referring now to (201), in more detail, an advertising router receives economic data from a plurality of placement channels used to place a publisher's impression inventory. The advertising router may be intermediary between the publisher's advertising server and the plurality of placement channels. An interface or interface module of an ad router may receive economic data from a plurality of placement channels or partners. The advertising router may interface with the publisher's advertising server without the use of advertising tags.

The ad router may receive economic data from a plurality of placement channels, the plurality of placement channels comprising at least one of: an advertising network, a supply-side platform, a demand-side platform and an advertising exchange. The ad router may receive, via a placement channel interface for example, data from one or more placement channels, placement partners or secondary channels, e.g., SSP, DSP, ad networks, and ad exchanges. The ad router may receive pricing, bid, campaign or transaction data from the plurality of placement channels. The data received may include any type or form of economic data, for example real-time and/or historical pricing, bid, campaign and/or transaction data as discussed above in connection with FIG. 2A. In some embodiments, the ad router may receive or access one or more files generated or output by one or more placement channels. The one or more files may include economic data from the one or more placement channels.

The ad router (e.g., via an interface module, or the placement channel interface) may access, request for, receive, poll, extract, process and/or normalize data from one or more of the placement channels, for example, in any manner as discussed above in connection with FIG. 2A. For example, the ad router may normalize (e.g., via the interface module or the optimization engine) the received economic data across the plurality of placement channels.

In some embodiments, the ad router may receive, via the placement channel interface or otherwise, third party analytics or segment information from entities such as Bluekai and Exelate. The ad router may receive one or more files with the data, generated or output by one or more placement channels. The ad router may receive data comprising economic data, e.g., pricing, bid and transaction information as discussed above in connection with FIG. 2A.

Referring now to (203), in more detail, the advertising router may receive impression inventory data from the publisher's advertising server. The ad router may receive, via the interface module, or another (e.g., second) interface, impression inventory data from a publisher's ad server. The ad router may generate and/or receive one or more business rules. The ad router may receive, via an ad server interface, data from a publisher's ad server. The ad router may access, request, receive, poll, extract and/or process data from the ad server, for example as discussed above in connection with FIG. 2A.

The ad router may receive ad server data including any information related to one or a plurality of impressions, such as ad size, impression type, website section, user information, channel information, etc, as discussed above in connection with FIG. 2A. The ad router may receive ad server data including any information related to the publisher's impression inventory on one or more sites, e.g., total inventory, forecasts, historical clearing prices and take-up, bid prices, etc, as discussed above in connection with FIG. 2A.

The ad router may receive one or more business rules of the publisher, of a publisher site, of a campaign, and/or of an advertiser. The ad router may access the logic or a configuration or database of the ad server to access the business rules. In some embodiments, the publisher and/or advertiser may provide the ad router with the business rule, e.g., in a policy file and/or via a user interface of the ad router. The ad router may receive one or more business rules specifying one or more goals, objectives, campaign criteria (e.g., CPM, CTR), threshold values (e.g., floor rate or minimum accepted bid price for impressions), for example as discussed above in connection with FIG. 2A. The business rules may identify, instruct, direct or control the ad router in routing placements, making decisions and/or recommendations for maximizing the economic yield (e.g., margin or revenue yield) of the publisher's remnant inventory. In some embodiments, the ad router may receive any of the ad server data, placement channel data and/or business rules via a single interface or a plurality of interfaces.

Referring now to (205), in more detail, the advertising router may generate, based on the impression inventory data, a forecast of economic yield of the publisher's impression inventory. For example, a simulator and/or optimization engine of the ad router may generate a performance forecast of the publisher's impression inventory. The ad router may generate the forecast of the publisher's impression inventory based on the impression inventory data and one or more business rules. The ad router may receive some portion of the data and/or business rules received and/or processed by one or both of the ad server interface and the placement channel interface. The ad router may organize the data in context, e.g., matching pieces of data temporally in time, and/or related by campaign, website section, type of impression, etc.

The ad router (e.g., via its simulator and/or optimization engine) may analyze historical data and may compare or test its analysis with present performance. The ad router may make assumptions, projections, estimations or intelligent guesses to complement data which may be missing, outdated or not available. The ad router may use pre-configured or default values to complement data which may be missing, outdated or not available. The ad router may request additional information from the publisher, ad server and/or placement channel(s). In some embodiments, the ad router simulates or forecasts the performance or economic yield, and/or lack thereof, of the publisher's remnant inventory across secondary channels.

The ad router (e.g., via its simulator and/or optimization engine) may analyze historical data and/or present developments for trends and/or modeling checkpoints. The ad router may generate a model or algorithm for one or more campaigns, based on the received data and/or business rules. The ad router may generate a model for analyzing inventory changes, availability and performance. The ad router may generate a forecast of the impression inventory, economic or other performance of the inventory, and/or performance of a specific campaign and across a plurality of campaigns. The forecast may be generated based in part on the generated model(s), inferred trend(s), received data, third-party data, assumptions, projections and/or business rules. The ad router may generate a forecast, scenario analysis or simulation to test assumptions and/or to compare against present developments. The ad router may generate a forecast as a baseline for optimization. The ad router may generate a forecast for comparison against scenarios which may result if a change (e.g., in business rules, campaign strategy, inventory structure, etc) is applied.

The ad router may determine at least one recommendation to maximize economic yield from the publisher's remnant impression inventory. The ad router (e.g., via its simulator and/or optimization engine) may generate a forecast or prediction of the current economics (e.g., yield, returns or other metric) of the publisher's remnant inventory. The ad router may generate a forecast of the improved economics of the publisher's remnant inventory based on decisions and/or recommendations of the ad router. The ad router may generate a forecast of the improved economics of the publisher's remnant inventory across a selected set of one or more placement or secondary channels. The ad router may generate a forecast of the improved economics of the publisher's remnant inventory based on day or week parts and/or geo data.

Referring now to (207), in more detail, the advertising router may determine, based on the forecast, at least one recommendation to improve the economic yield. For example, an optimization engine of the ad router may determine or generate at least one recommendation to improve yield or performance of the publisher's impression inventory. The optimization engine may incorporate some portion of the simulator. The optimization engine may use any one or more of the assumptions, data, business rules, trends, models and forecasts used or generated by the simulator. The ad router, e.g., via the optimization engine, may identify variables, e.g., in the models or business rules, that may improve inventory or campaign performance. The optimization engine may identify one or more variables that may be incorporated into one or more recommendations for optimizing inventory performance (e.g., campaign performance, returns on the inventory, inventory uptake, etc). The optimization engine may vary and test the variables, e.g., by interoperating with or invoking the simulator.

The ad router (e.g., via the optimization engine) may incorporate new or updated data, e.g., dynamically received or requested from the ad server, third-parties and/or placement channels. The ad router may incorporate one or more feedback loops to update or improve the optimization engine's analysis, calculations and/or optimizations. The ad router, e.g., via the optimization engine and/or the simulator, may employ any number and combination of algorithms to analyze or predict performance changes based on any variables that may be changed or tested. The ad router may identify one or more recommendations to improve inventory performance or returns, e.g., based on the analysis and/or predictions. The ad router may determine the at least one recommendation based on metrics or goals of the publisher. The ad router may organize or rank the impact of variable changes and/or recommendations on the yield or performance of the inventory.

The ad router may identify one of the plurality of placement channels for placement of an impression. The ad router (e.g., via the optimization engine) may select the placement or secondary channels which may improve, optimize or maximize the economic yield (e.g., revenue or margin yield) of the publisher's inventory, e.g., remnant inventory. The ad router may select the secondary channels which may improve, optimize or maximize the revenue of the publisher's remnant inventory. The ad router may select the secondary channels which may improve, optimize or maximize the margin yield of the publisher's remnant inventory. The optimization engine may select the secondary channels based on day/week parts, geo data, categories and/or pricing.

Referring now to (209), in more detail, the advertising router may apply the at least one recommendation to place an impression of the impression inventory through the plurality of placement channels. The ad router may modify, via the interface module (e.g., second interface) based on the at least one recommendation, the ad server's logic for placement of the impression inventory, e.g., through the plurality of placement channels. In some embodiments, the ad router presents one or more recommendations to the publisher or campaign administrator, e.g., via the visualizer described above in connection with FIG. 2A. The ad router may rank the recommendations according to objectives or goals of the publisher and/or a campaign. The ad router may report projected or predicted performance changes corresponding to a recommendation. The ad router may compare the predicted performance changes against performance forecast(s), e.g., based on present data and business rules.

The ad router may make recommendations and/or placement routing decisions to improve, optimize or maximize the economic yield of the publisher's remnant inventory. The ad router may make decisions and/or recommendations to maximize the revenue for remnant inventory of the publisher across one or more secondary channels, such as SSPs, DSPs and AdNets. The ad router may make decisions and/or recommendations to maximize the margin yield for remnant inventory of the publisher across one or more secondary channels, such as SSPs, DSPs and AdNets. For example, the ad router may recommend and/or route to a specific or selected secondary channel based on projected economic yield or performance for a predetermined day or week part. The ad router may recommend and/or route to a specific or selected secondary channel based on projected economic yield or performance for a predetermined geolocation.

In certain embodiments, the ad router or optimization engine may implement a recommendation, either automatically or based on feedback from a publisher or campaign administrator. For example, the optimization engine may implement a recommendation based on a preconfigured setting in the ad router or ad server to automatically implement a recommendation. In some embodiments, the optimization engine may implement a recommendation that a publisher or campaign administrator selected or approved (e.g., from one or more recommendations presented by the ad router). The ad router may update, reprogram or modify the logic, configuration, behavior, or programming of the ad server based on the recommendation. For example, the ad router may update a configuration file and/or business rule of the ad server. In some embodiments, the ad router may determine a placement channel for one or more impression opportunities. This determination may comprise a recommendation for improving performance or returns. For example, the ad router may accept a lower bid for a particular impression to improve returns from the rest of the inventory.

The ad router may, in certain embodiments, send a request, command or instruction to the ad server to serve or place an impression opportunity with a selected placement channel. In some implementations, the ad router may make certain decisions regarding matching an impression opportunity with, or assigning it to a placement channel. For example, the ad router may integrate with the ad server as a wrapper, master, layer or direct interface to the one or more placement channels. The ad router may serve, direct or provide an impression opportunity to a placement channel on behalf of the ad server or publisher. The ad router may monitor the progress of one or more campaigns, inventory changes and/or inventory performance. For example, the ad router may receive or access information on transaction and/or corresponding advertisement, e.g., as described above. The ad router may incorporate the information into the ad router's forecast and optimization, e.g., as feedback to generate refinements, incremental optimizations, changes and/or recommendations to improve performance and returns.

The ad router may interact with one or more ad networks, DSPs, SSPs, ad exchanges and/or other placement channels without any of the placement channels being aware of the presence, role and/or impact of the ad router or other placement channels.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the invention has been particularly shown and described with reference to specific embodiments, it should be understood by those skilled in the art that various changes in form and detail may be made therein without departing from the spirit and scope of the invention.

1. A method for optimizing economic yield from a publisher's impression inventory, the method comprising:
(a) receiving, by an advertising router, economic data from a plurality of placement channels used to place a publisher's impression inventory, the plurality of placement channels providing advertisement for placing the publisher's impression inventory, the advertising router intermediary between the publisher's advertising server and the plurality of placement channels;
(b) receiving, by the advertising router, impression inventory data from the publisher's advertising server;
(c) generating, by the advertising router based on the impression inventory data, a forecast of economic yield of the publisher's impression inventory;
(d) determining, by the advertising router based on the forecast, at least one recommendation to improve the economic yield; and
(e) applying, by the advertising router, the at least one recommendation to place an impression of the impression inventory through the plurality of placement channels.

2. The method of claim 1, wherein (a) comprises receiving economic data from a plurality of placement channels, the plurality of placement channels comprising at least one of:
an advertising network, a supply-side platform, a demand-side platform and an advertising exchange.

3. The method of claim 1, wherein (a) comprises receiving pricing or transaction data from the plurality of placement channels.

4. The method of claim 1, wherein (a) further comprises normalizing the received economic data across the plurality of placement channels.

5. The method of claim 1, further comprising interfacing the advertising router with the publisher's advertising server without the use of advertising tags.

6. The method of claim 1, wherein (c) comprises generating the forecast of the publisher's impression inventory based on the impression inventory data and one or more business rules.

7. The method of claim 1, wherein (d) comprises determining the at least one recommendation to maximize economic yield from the publisher's remnant impression inventory.

8. The method of claim 1, wherein (d) comprises identifying one of the plurality of placement channels for placement of the impression.

9. The method of claim 1, wherein (d) comprises determines the at least one recommendation based on metrics or goals of the publisher.

10. The method of claim 1, wherein (e) comprises modifying, based on the at least one recommendation, the advertising server's logic for placement of the impression through the plurality of placement channels.

11. A system for optimizing economic yield from a publisher's impression inventory, the system comprising:
an interface module of an advertising router, receiving economic data from a plurality of placement channels used to place a publisher's impression inventory, and receiving impression inventory data from the publisher's advertising server, the advertising router intermediary between the advertising server and the plurality of placement channels, the plurality of placement channels providing advertisement for placing the publisher's impression inventory; and
an optimization engine of the advertising router, the optimization engine executing on a processor, generating a forecast of economic yield of the publisher's impression inventory based on the impression inventory data, and determining at least one recommendation based on the forecast to improve the economic yield, the advertising router applying the at least one recommendation to place an impression of the impression inventory through the plurality of placement channels.

12. The system of claim 11, wherein the interface module receives the economic data from the plurality of placement channels, the plurality of placement channels comprising at least one of: an advertising network, a supply-side platform, a demand-side platform and an advertising exchange.

13. The system of claim 11, wherein the interface module receives pricing or transaction data from the plurality of placement channels.

14. The system of claim 11, wherein the optimization engine normalizes the received economic data across the plurality of placement channels.

15. The system of claim 11, wherein the interface module interfaces with the publisher's advertising server without the use of advertising tags.

16. The system of claim 11, wherein the optimization engine generates the forecast of the publisher's impression inventory based on the impression inventory data and one or more business rules.

17. The system of claim 11, wherein the optimization engine determines the at least one recommendation to maximize economic yield from the publisher's remnant impression inventory.

18. The system of claim 11, wherein the optimization engine identifies one of the plurality of placement channels for placement of the impression.

19. The system of claim 11, wherein the optimization engine determines the at least one recommendation based on metrics or goals of the publisher.

20. The system of claim 11, wherein the optimization engine modifies, based on the at least one recommendation, the advertising server's logic for placement of the impression through the plurality of placement channels.
